(19) United States
(12) Patent Application Publication
(10) Pub. No.: US 2009/0262971 A1
(43) Pub. Date: Oct. 22, 2009

(54) Speaker

(76) Inventor: Osamu Funahashi, Osaka (JP)

Correspondence Address: WENDEROTH, LIND & PONACK L.L.P., 1030 15th Street, N.W., Suite 400 East, Washington, DC, 20005-1503, US

(21) Appl. No.: 11/662,052

(22) PCT Filed: Sep. 26, 2006
(86) PCT No.: PCT/JP2006/319051

§ 371 Date: Mar. 7, 2007

(30) Foreign Application Priority Data
Oct. 11, 2005 (JP) 2005-296285

(51) Int. Cl. H04R 9/04

(52) U.S. Cl. 381/398

(57) ABSTRACT

An uncured fluid adhesive is charged into a groove surrounding the outer circumference of a voice coil so that the inner circumferential edge of a diaphragm is immersed in the adhesive. The cured adhesive securely bonds the diaphragm to the voice coil, and thus the diaphragm can be driven at high output.

### TECHNICAL FIELD

The present invention relates to the structure of a speaker.

### BACKGROUND ART

FIG. 3 is a partially sectional view of a conventional speaker. Voice coil 22 is disposed in the magnetic gap in magnetic circuit 21. The inner circumferential edge of diaphragm 23 is connected to voice coil 22. The outer circumferential edge of diaphragm 23 is coupled to frame 25 via edge 24. The backside of diaphragm 23 is coupled to frame 25 via suspension holder 26 and edge 27. The symmetrical structure of edges 24 and 27 allows diaphragm 23 to vibrate as symmetrically as possible in the vertical direction, thereby reducing distortion of the speaker. This conventional art is disclosed in Japanese Patent Unexamined Publication No. 2004-7332, for example.

The conventional speaker of FIG. 3 has low distortion even when diaphragm 23 is vibrated with large amplitude to increase output thereof. However, the connection between diaphragm 23 and voice coil 22 may be damaged by the excessive load imposed thereon.

### SUMMARY OF THE INVENTION

A speaker of the present invention includes: a frame; a magnetic circuit disposed in the frame; a voice coil disposed movably with respect to the magnetic gap in the magnetic circuit; a groove surrounding the outer circumference of the voice coil; a diaphragm having an inner circumferential edge disposed in the groove, and an outer circumferential edge coupled to the frame via a first edge; and a suspension holder connected to the backside of the diaphragm and having an outer circumferential edge coupled to the frame via a second edge. The inner circumferential edge of the diaphragm is bonded to the voice coil by an adhesive charged into the groove. The diaphragm and voice coil are securely bonded and this high bonding strength can increase the output of the speaker.

### BRIEF DESCRIPTION OF THE DRAWINGS

FIG. 1 is a sectional view of a speaker in accordance with an exemplary embodiment of the present invention.

FIG. 2 is an enlarged sectional view of an essential part of the speaker.

FIG. 3 is a partially sectional view of a conventional speaker.

### REFERENCE MARKS IN THE DRAWINGS

1 Magnetic circuit
2 Voice coil
2a Coil
3 Diaphragm
4 Edge (first edge)
5 Frame
7 Edge (second edge)
8 Magnetic gap
10 Suspension holder
12 Groove
13 Adhesive
14 Clearance

### DETAILED DESCRIPTION OF PREFERRED EMBODIMENT

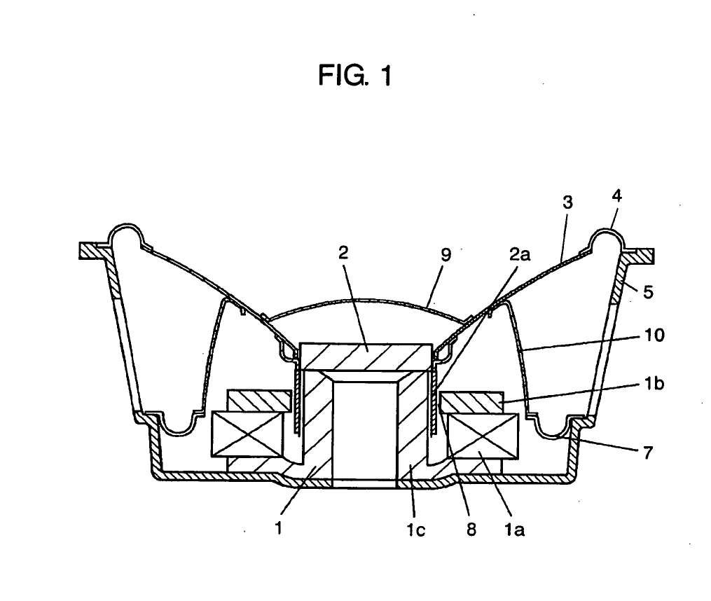

Hereinafter, a description is provided of an exemplary embodiment of the present invention, with reference to the accompanying drawings. FIG. 1 is a sectional view of a speaker in accordance with an exemplary embodiment of the present invention. Magnetic circuit 1 is disposed in the center of the bottom of frame 5. Magnetic circuit 1 includes disk-shaped magnet 1a, disk-shaped plate 1b, cylindrical yoke 1c, and magnetic gap 8 formed between plate 1b and yoke 1c.

Voice coil 2 is disposed to be vertically movable with respect to magnetic gap 8, and vertically vibrates diaphragm 3, i.e. the sound source of the speaker, connected to voice coil 2. Dustproof dust cap 9 is provided over voice coil 2.

The outer circumferential edge of diaphragm 3 is coupled to the open end of frame 5 via edge 4 (first edge). The inner circumferential edge of diaphragm 3 is bonded to voice coil 2. Suspension holder 10 is bonded to the backside of diaphragm 3. The outer circumferential edge of suspension holder 10 is coupled to frame 5 via edge 7 (second edge). Suspension holder 10 is a mass added to diaphragm 3 and thus decreases the efficiency of the speaker. For this reason, preferably, the suspension holder is as lightweight as possible, and made of pulp or resin.

Edges 4 and 7 are made of a material, such as urethane, expanded rubber, styrene-butadiene rubber (SBR), and cloth, so that the edges do not impose a dynamic load on diaphragm 3 and suspension holder 10. Edge 4 projects upwardly. Edge 7 projects downwardly. The symmetrical structure of edges 4 and 7 decreases the distortion generated when diaphragm 3 vertically vibrates.

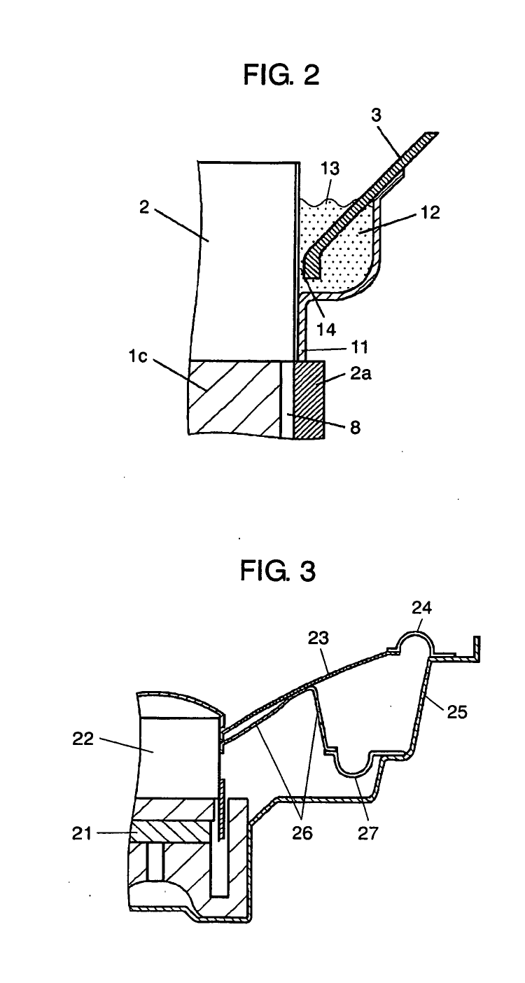

FIG. 2 illustrates how diaphragm 3 is bonded to voice coil 2. Groove 12 is disposed to surround the outer circumference of voice coil 2. Preferably, bottom part 11 of groove 12 is in contact with coil 2a of voice coil 2 to position groove 12. The dimension of the upper end of coil 2a of voice coil 2 is precisely controlled. Thus, bringing bottom part 11 of groove 12 into contact with the upper end of coil 2a allows diaphragm 3 to precisely be positioned with respect to voice coil 2.

Uncured fluid adhesive 13 is charged into groove 12 so that the inner circumferential edge of diaphragm 3 is immersed in adhesive 13. Alternatively, after the inner circumferential edge of diaphragm 3 is disposed in groove 12, uncured adhesive 13 is charged into groove 12. To allow adhesive 13 to flow easily, clearance 14 is provided between the outer circumference of voice coil 2 and diaphragm 3. Cured adhesive 13 integrally bonds the inner surface of groove 12, outer circumference of voice coil 2, and diaphragm 3.

For this reason, acrylic adhesives used by the reaction of two liquids are suitable as adhesive 13, because such adhesives have high fluidity when uncured, and dry quickly. As a result, diaphragm 3 is securely bonded to voice coil 2, and can be driven at high output.

### INDUSTRIAL APPLICABILITY

The present invention can provide a speaker having reduced distortion and a diaphragm driven at high output, and thus is useful as a speaker with high output and low distortion.

1. A speaker comprising:
a frame;
a magnetic circuit disposed in the frame;
a voice coil disposed movably with respect to a magnetic gap in the magnetic circuit;
a groove surrounding an outer circumference of the voice coil;
a diaphragm having an inner circumferential edge disposed in the groove, and an outer circumferential edge coupled to the frame via a first edge; and
a suspension holder connected to a backside of the diaphragm and having an outer circumferential edge coupled to the frame via a second edge,
wherein the inner circumferential edge of the diaphragm is bonded to the voice coil by an adhesive charged in the groove.

2. The speaker of claim 1, wherein a clearance is provided between the inner circumferential edge of the diaphragm and the voice coil.

3. The speaker of claim 1, wherein a bottom part of the groove is in contact with a coil of the voice coil.

4. The speaker of claim 2, wherein a bottom part of the groove is in contact with a coil of the voice coil.
